(19) United States
(12) Patent Application Publication
(10) Pub. No.: US 2026/0010053 A1
(43) Pub. Date: Jan. 8, 2026

(54) CURRENT-ASSISTED PHOTONIC DEMODULATOR WITH REDUCED ENERGY CONSUMPTION

(71) Applicant: COMMISSARIAT A L'ENERGIE ATOMIQUE ET AUX ENERGIES ALTERNATIVES, Paris (FR)

(72) Inventors: Abdelkader ALIANE, Grenoble Cedex 09 (FR); Hacile KAYA, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/216,817

(22) Filed: May 23, 2025

(30) Foreign Application Priority Data
May 30, 2024 (FR) FR2405648

(51) Int. Cl. G02F 2/00

(52) U.S. Cl. CPC G02F 2/00

(57) ABSTRACT

The invention relates to a current-assisted photonic demodulator (1), adapted to detect light radiation, comprising:
a detection portion (10), made based on germanium, extending vertically between a rear face (Far) and a front face (Fav) parallel with a main plane, the front face (Fav) being intended to receive light radiation, comprising modulation regions (11) and collection regions (12);
a dielectric layer (22), made of at least one electrically insulating material, and extending on and in contact with the rear face (Far);
at least one central electrode (EC), intended to be positively polarized, partially passing through the dielectric layer (22) and spaced apart from the rear face (Far) by a non-zero distance, located facing the central zone (Zc) and disposed, in projection in the main plane, between the modulation regions (11).

### CROSS REFERENCE TO RELATED APPLICATIONS

This application claims the priority benefit of French patent application number 24/05648, filed on May 30, 2024, entitled “CURRENT-ASSISTED PHOTONIC DEMODULATOR WITH REDUCED ENERGY CONSUMPTION”, which is hereby incorporated by reference to the maximum extent allowable by law.

### TECHNICAL FIELD

The field of the invention is that of current-assisted photonic demodulators (CAPD) configured to detect light radiation in the near infrared. The invention is particularly applicable in telemetry, biological analysis, and industrial inspection (contactless surface defect detection).

### PRIOR ART

Current-assisted photonic demodulators are photodetectors wherein the distribution of a drift electric field field is modulated. They were initially particularly described in the scientific article by Van Nieuwenhove et al. entitled Novel Standard CMOS Detector using Majority Current for guiding Photo-Generated Electrons towards Detecting Junctions, Proc. Symp. IEEE/LEOS Benelux Chapter, pp. 229-232, 2005. This type of optoelectronic device is particularly used in time-of-flight (TOF) telemetry.

Such a demodulator typically comprises a detection portion made of a material based on an unintentionally doped or lightly p-doped crystalline semiconductor, which has, at one of its faces, two p+ doped regions for generating and modulating a drift current, as well as two n+ doped regions located near the p+ doped regions for collecting the photocurrent. An electric potential difference is applied between the p+ doped regions, while applying a positive electronic potential to the n+ doped regions (positive voltage) so as to form two reverse polarized diodes (p+n+) on each side of the CAPD, thereby generating a drift electric field within the detection portion. Thus, when light radiation is absorbed in the detection portion, an electron-hole pair is generated, then the photogenerated hole propagates under the effect of the drift electric field toward the p+ doped region having the lowest electrical potential, while the photogenerated electron is directed towards the opposite p+ doped region, then is collected by the adjacent n+ doped region. In this way, the photocurrent (minority electrons) can be efficiently measured by the demodulator.

Due to the separation between the current of the majority holes and the photocurrent (minority electrons), the contribution of the current of the major holes to the Schottky noise (shot noise) and to the thermal noise is limited.

However, it is also important to reduce the power consumption associated with the current of the majority holes (modulation current). There are different options, such as reducing the doping level of the detection portion to increase the resistivity of the material. However, this solution may affect the demodulator bandwidth and consequently reduce the operating frequency. Another solution consists of reducing the potential difference applied between the modulation electrodes. However, this may result in a reduction in the demodulation contrast.

### DISCLOSURE OF THE INVENTION

The invention aims to remedy at least partially the drawbacks of the prior art, and more particularly to provide a current-assisted photonic demodulator, configured to detect in the near infrared, and having good performances (in terms of demodulation contrast and bandwidth) while having a reduced power consumption.

For this purpose, the invention relates to a current-assisted photonic demodulator, adapted to detect light radiation, comprising:
a detection portion, made of a material based on germanium, extending vertically between a rear face and a front face parallel with a main plane, the front face being intended to receive light radiation, comprising:
   at least two p-doped modulation regions, adapted to generate and modulate a drift current in the detection portion, flush with the rear face and located on either side of a central zone of the detection portion;
   at least two n-doped collection regions, adapted to collect the photogenerated minority charge carriers during the absorption of light radiation in the detection portion, flush with the rear face and located on either side of the central zone and the modulation regions;
a dielectric layer, made of at least one electrically insulating material, and extending on and in contact with the rear face.

According to the invention, the demodulator comprises at least one central electrode, intended to be positively polarized, partially passing through the dielectric layer and spaced apart from the rear face by a non-zero distance, located facing the central zone and disposed, in projection in the main plane, between the modulation regions.

Some preferred but non-limiting aspects of this current-assisted photonic demodulator are as follows.

The central electrode can be spaced apart from the rear face of the detection portion by a distance between 20 and 50 nm.

The dielectric layer, in an interposed part located between the central electrode and the rear face of the detection portion, can be made of at least one material selected from a silicon, aluminum, hafnium, zirconium or germanium oxide.

The central electrode can extend laterally, in projection in the main plane, to the edges of the modulation regions.

The demodulator can comprise a peripheral lateral portion surrounding the detection portion in the main plane, made of a silicon-based semiconductor material.

The detection portion can comprise a lateral zone made of a material based on SiGe, located at the interface with the peripheral lateral portion.

The central electrode can comprise a thin conductive layer which extends into the dielectric layer and a conductive pad coming into contact with the thin conductive layer.

The demodulator can comprise collection electrodes, passing through the dielectric layer and coming into electrical contact with the collection regions; and modulation electrodes, passing through the dielectric layer and coming into electrical contact with the modulation regions.

The invention also relates to a method for manufacturing a photonic demodulator according to any one of the preceding features, comprising the following steps:
producing the detection portion made of an unintentionally doped or lightly p-doped germanium-based compound;
producing the p-doped modulation regions and the n-doped collection regions in the detection portion;
depositing a dielectric layer on the rear face of the detection portion;
producing the central electrode through a part of the dielectric layer.

### BRIEF DESCRIPTION OF THE DRAWINGS

Other aspects, aims, advantages and features of the invention will become apparent upon reading the following detailed description of preferred embodiments thereof, provided as a non-limiting example with reference to the appended drawings wherein:

FIGS. 1A and 1B are schematic and partial views, in cross-section (FIG. 1A) and in top view (FIG. 1B), of a current-assisted photonic demodulator according to one embodiment;

FIGS. 2A and 2B illustrate the evolution, according to the difference in electric potential applied between the modulation electrodes, of the modulation current intensity (FIG. 2A) and the dissipated electric power (FIG. 2B), for different values of electric potential applied to the central electrode;

FIGS. 3A to 3H illustrate different steps of a method for manufacturing a demodulator similar to that of FIG. 1A.

### DETAILED DISCLOSURE OF PARTICULAR EMBODIMENTS

In the figures and in the following description, the same reference numerals represent identical or similar elements. In addition, the various elements are not shown to scale to ensure that the figures are clear. Moreover, the various embodiments and variants are not mutually exclusive and may be combined. Unless stated otherwise, the terms “substantially”, “about”, “in the order of” mean within a 10% margin, and preferably within a 5% margin. Moreover, the terms “between . . . and . . . ” and equivalents mean that the bounds are included, unless stated otherwise.

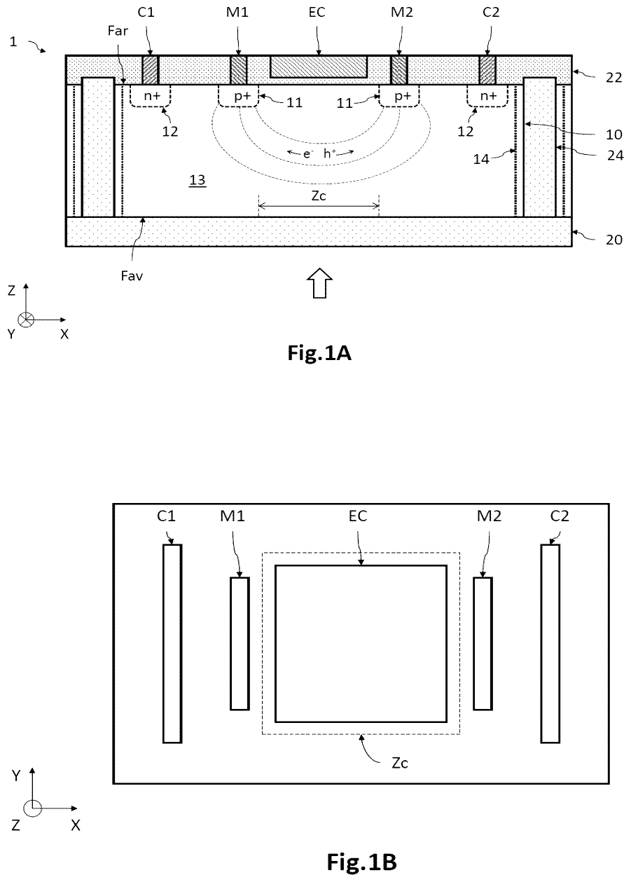

FIGS. 1A and 1B are schematic and partial views, in cross-section (FIG. 1A) and in top view (FIG. 1B), of a current-assisted photonic demodulator 1 according to an embodiment, here belonging to an array of identical planar demodulators.

Here and hereinafter in the description, an orthogonal three-dimensional direct reference frame XYZ is defined, where the axes X and Y form a plane parallel with the main plane of the demodulator 1, and where the direction +Z is oriented from the front face Fav to the rear face Far (along the direction of layer growth). Hereinafter in the description, the terms “lower” and “upper” are understood as relating to an increasing positioning along the direction +Z. Moreover, the term “horizontal” refers to an orientation parallel with the plane XY and the term “vertical” refers to an orientation parallel with the axis Z.

The current-assisted photonic demodulator 1 is adapted to detect light radiation in the near-infrared spectral band (SWIR) corresponding to the spectral range from about 0.8 μm to 1.7 μm, or even up to about 2.5 μm. It is therefore adapted to detect light radiation having a wavelength ranging from 800 nm to a cut-off wavelength greater than 1550 nm.

As a general rule, the demodulator 1 comprises:
a detection portion 10 made of a material based on germanium, which extends vertically between a rear face Far and a front face Fav through which light radiation is received. It comprises:
   at least two p-doped modulation regions 11, adapted to generate and modulate the drift current, flush with the rear face Far and located on either side of a central zone Zc of the detection portion 10; and
   at least two n-doped collection regions 12, adapted to collect the photogenerated minority carriers, flush with the rear face Far and located on either side of the central zone Zc and the doped modulation regions 11;
a so-called dielectric layer 22, made of at least one electrically insulating material, which extends on and in contact with the rear face Far of the detection portion 10;
electrodes located at the rear face Far, of which modulation electrodes M1, M2 in electrical contact with the doped modulation regions 11; and collection electrodes C1, C2 in electrical contact with the doped collection regions 12;
at least one central electrode EC, intended to be positively polarized, partially passing through the dielectric layer 22 and spaced apart from the rear face Far by a non-zero distance, located facing the central zone Zc and disposed, in projection in the main plane, between the two doped modulation regions 11.

As shown in the figures, the central electrode EC preferably extends parallel to the main plane. In the cross-sectional views, the rear face Far is substantially planar. Alternatively, it may not be planar. For example, it may have a depression extending into the detection portion 10, less deeply than the modulation regions 11. If applicable, the dielectric layer 22 conforms to this depression. The depression may extend between the modulation regions 11, facing the central electrode EC.

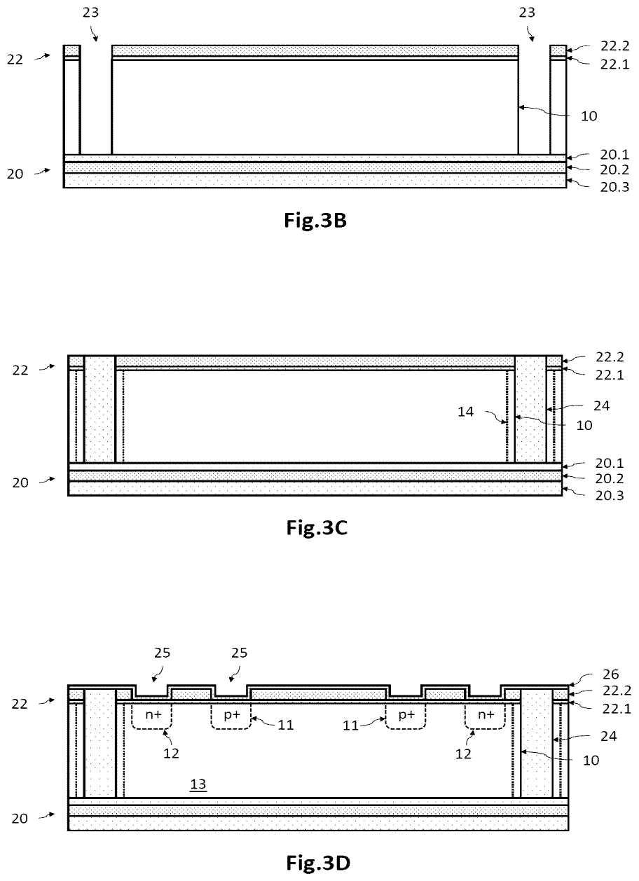

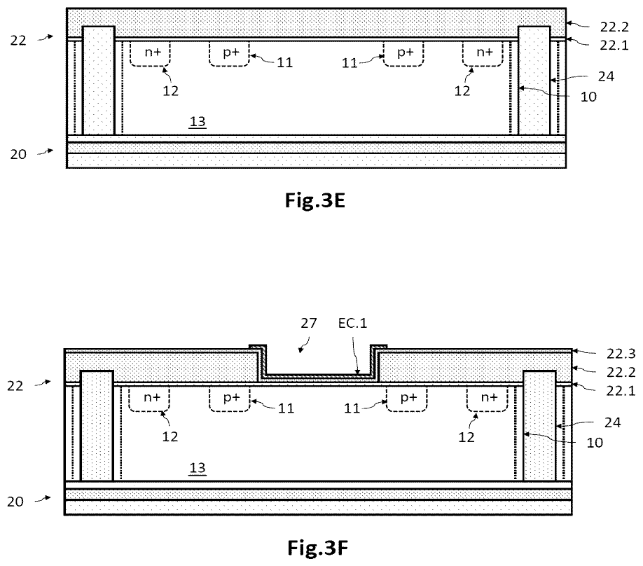

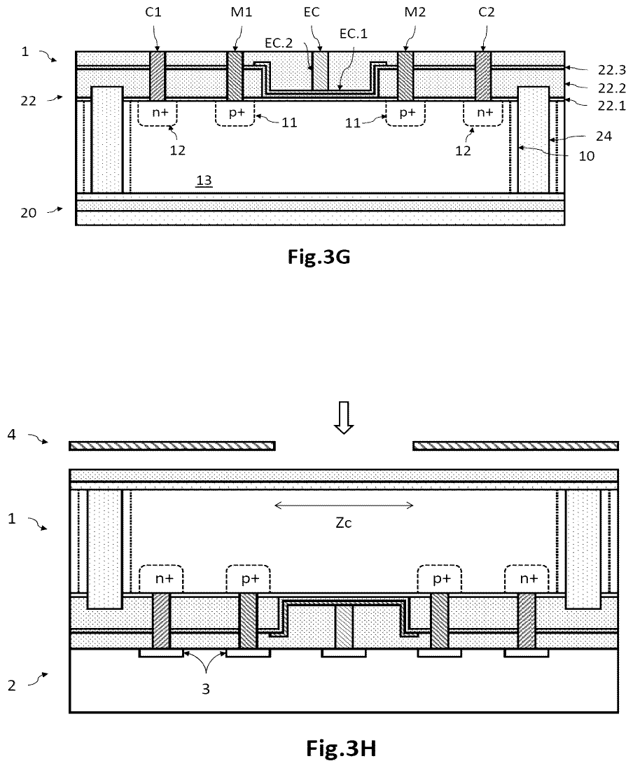

The demodulator 1 preferably belongs to an array photodetector comprising an array of detection pixels identical to each other, where each detection pixel comprises a planar demodulator. The configuration is referred to as planar in that each demodulator 1 is made from the same main semiconductor layer 21 (see FIG. 3A). The latter extends into a main plane XY between the rear face Far and front face Fav opposite each other and parallel with the main plane. Hence, the two faces Far, Fav extend along identical planes for each of the demodulators 1, and vertically (along the thickness axis Z) delimit the detection portions 10 of the demodulators 1. In addition, the demodulators 1 do not have a mesa structure in that are made from the same main semiconductor layer. The front face Fav is that which receives the light radiation to be detected.

Each demodulator 1 comprises a detection portion 10 made of a material based on germanium and therefore adapted to detect light radiation in the near-infrared (SWIR). The detection portion 10 is a part of the main semiconductor layer 21. Insofar as the detection portion 10 is made of a material based on germanium and may undergo tensile mechanical stress in the plane XY (as described hereinafter), the demodulator 1 may be adapted to detect light radiation at a cut-off wavelength greater than 1.55 μm.

The thickness of the detection portion 10, defined along the axis Z between the rear face Far and front face Fav, is here substantially constant from one demodulator 1 to another, for example is between a few hundred nanometers and a few microns, for example between about 1 μm and 5 μm, and preferably 1.5 μm. The thickness is selected so as to obtain a good absorption in the wavelength range of the light radiation to be detected. The detection portion 10 has a transverse dimension in the plane XY which may be between a few hundred nanometers and a few tens of microns, for example between about 1 μm and 20 μm, for example equal to 10 μm.

The detection portion 10 is made of at least one germanium-based crystalline semiconductor material, i.e. the semiconductor material(s) are germanium or a compound (binary or ternary, etc.) formed of at least germanium. Thus, the detection portion 10 may be made, for example, of germanium Ge, of germanium silicon SiGe, of germanium tin GeSn, and possibly of silicon germanium tin SiGeSn. Thus, it may be made of the same semiconductor material and have regions with different conductivity types (homojunction) so as to form a pn or pin junction. Alternatively, it may consist of a stack of sublayers of different semiconductor materials (heterojunction), which are then formed based on germanium. Preferably, the detection portion 10 is made of germanium.

A central zone Zc of the detection region 10 is defined as the main location of absorption of the light radiation to be detected. This central zone Zc is advantageously delimited in the plane XY by an optical mask 4 located on the side of the front face Fav which receives the light radiation to be detected (see FIG. 3H).

The detection portion 10 comprises an unintentionally doped (with optional residual p-doping) or lightly p-doped intermediate region 13. The intermediate region 13 extends between the faces Far and Fav, as well as in the plane XY, and forms the main absorption region of the light radiation to be detected. It surrounds, in the plane XY, the doped modulation regions 11 and the doped collection regions 12.

The detection portion 10 includes at least two p-doped, here p+ doped, modulation regions 11, adapted to generate and modulate the drift current via the electric potential applied thereto by the modulation electrodes M1 and M2. They are here p+ doped, and have for example a doping between about 10¹⁸ and 10²⁰ at/cm³, preferably 10¹⁹ at/cm³. They are flush with the rear face Far and extend in the direction of the front face Fav along the axis Z on a predefined depth. The depth can here be defined as the distance along the axis Z between the rear face Far and a zone where the doping level is locally equal to half the maximum doping level. Moreover, the two doped modulation regions 11 are located in the plane XY on either side of the central zone Zc of the detection portion 10.

The detection portion 10 also comprises at least two n-doped, here n+ doped, collection regions 12, adapted to collect the photogenerated minority carriers (photocurrent) from the absorption of the light radiation to be detected in the intermediate region, via the electric potential applied thereto by the collection electrodes C1 and C2. They are n+ doped here, and can have a doping that can be between about 5×10¹⁸ and 10²⁰ at/cm³. They are flush with the rear face Far and extend in the direction of the front face Fav along the axis Z on a predefined depth. Moreover, the two doped collection regions 12 are located adjacent and very close to the doped modulation regions 11.

Note that the doped modulation regions 11 and the doped collection regions 12 can be produced, as in FIG. 1A, by localized ion implantation in the detection portion 10 from the rear face F1. Alternatively, as mentioned in patent application FR2212468 filed on Nov. 29, 2022, and published under number FR3142606, it can be carried out by growth doping during epitaxy regrowth in notches formed from the rear face Far of the detection portion 10.

Flush means “arriving at”, or “extends from”. The doped collection regions 12 and the doped modulation regions 11 are disposed in the plane XY on either side of the central zone Zc. In a configuration illustrated in FIG. 1A, the doped modulation regions 11 are disposed near the central zone Zc while the disposed collection regions 12 are at a distance from it.

The detection portion 10 is advantageously delimited laterally, in the plane XY, by a peripheral lateral portion 24, filled with a semiconductor material, preferably based on silicon, which may optionally be p-doped. The peripheral lateral portion 24 ensures a lateral optical isolation of the demodulators 1 in the plane XY, and advantageously ensures tensioning (in terms of mechanical stress) in the plane XY of the material of the detection portion 10, thus increasing the absorption cut-off wavelength of the incident light radiation. Here, it preferably extends over the entire thickness of the detection portion 10 to emerge at the support layer 20. The inner face of this peripheral lateral portion 24 then defines the lateral edge of the detection portion 10.

The semiconductor material is preferably made of a material based on silicon, for example amorphous silicon, mono or polycrystalline silicon, silicon germanium, so as to advantageously form a lateral zone 14 made based on silicon germanium. The lateral zone 14 is flush with the lateral edge and is in contact with the peripheral lateral portion 24. Thus, the lateral zone 14 has a band gap energy greater than that of the detection portion 10 made of germanium. This lateral “gap opening” makes it possible to reduce the sensitivity of the demodulator 1 to defects present near the trenches. Thus, the performances of the demodulator 1 are also improved.

The demodulator 1 includes a dielectric layer 22, made of at least one electrically non-conductive material, such as an insulating material and/or an intrinsic semiconductor material, which covers the rear face Far, and makes it possible to passivate the detection portion 10 and electrically insulate the electrodes M1, M2, C1, C2, EC from each other. It is thus in contact with the doped modulation regions 11 and the doped collection regions 12, as well as the intermediate region 13. It is preferably made of an oxide, such as an oxide of silicon, aluminum, germanium, hafnium, zirconium, etc. or for example of unintentionally doped (intrinsic) silicon. For example, it has a thickness between 20 nm and 500 nm. A material with a resistivity greater than 1E9 Ω·cm is considered to be electrically non-conductive or electrically insulating. An intrinsic semiconductor material fulfilling this condition is suitable for the invention for producing the dielectric layer 22.

The dielectric layer 22 includes an interposed part of non-zero thickness, preferably between 20 and 50 nm, which vertically spaces the central electrode EC apart from the rear face Far of the detection portion 10. This interposed part has a thickness dependent on the dielectric constant of its constituent material. This interposed part is made of a material selected from, for example, a silicon oxide such as SiO₂, aluminum oxide such as Al2O3, hafnium oxide such as HfO2, zirconium oxide such as ZrO2, or germanium oxide such as GeO2, among others. Preferably, such a material has a high dielectric constant (high-k). This interposed part can also comprise a thin layer (a few nanometers, e.g. 2 nm) of intrinsic silicon.

Moreover, the detection portion 10 rests on a support layer 20, here made of a crystalline semiconductor material adapted to epitaxy of the germanium of the detection portion 10. The support layer 20 is made of a material optically transparent to the light radiation to be detected. It can comprise a thin layer 20.1 made of silicon adapted to epitaxy of the main layer 21 (see FIG. 3A), and optionally an oxide layer 22.2. This support layer 20 can be obtained from an SOI substrate, an SiGeOi substrate or a GeOi substrate.

The demodulator 1 comprises modulation electrodes M1, M2, making it possible to generate and modulate the drift current, which pass through the dielectric layer 2 to come into contact with the doped modulation regions 11 and apply a positive or zero electric potential to them. They are connected to a control chip 2 (see FIG. 3H). It also comprises collection electrodes C1, C2, making it possible to collect the photogenerated electrons (photocurrent), which pass through the dielectric layer 22 to come into contact with the doped collection regions 12 and apply a positive electrical potential to them. They are also connected to the control chip 2.

According to the invention, the demodulator 1 also comprises at least one central electrode EC, partially passing through the dielectric layer 22 and spaced apart from the rear face Far by a non-zero distance. It is located facing the central zone Zc, and is disposed, in projection in the main plane, between the doped modulation regions 11. This spacing distance, defined along the axis Z, is preferably between 5 nm and 50 nm, and preferably equal to about 40 nm in the case of SiO2 (depending on the dielectric constant of the material of the interposed part of the dielectric layer 22). This central electrode EC is therefore not in contact with the rear face Far of the detection portion 10.

The central electrode EC is intended to be positively polarized, and the modulation electrodes M1, M2 and collection electrodes C1, C2 are intended to be positively polarized. The electric potential applied to the central electrode EC is obviously less than a threshold value at which a breakdown of the interposed portion of the dielectric layer 22 can occur.

In this example, only one central electrode EC is located facing the central zone Zc. Preferably, the central electrode EC extends laterally, in projection in the plane XY, to the edges facing the doped modulation regions 11. The edges are defined as a zone where the doping level is locally equal to half the maximum doping level.

The inventors observed that the presence of this central electrode EC, located facing the central zone ZC and disposed between the doped modulation regions 11 (in projection in the plane XY), makes it possible to reduce the intensity of the modulation current by electric field effect via the interposed part of the dielectric layer 22. Indeed, this field effect results in an accumulation of minority carriers (electrons) under the dielectric layer 22, at the rear face Far, under the central electrode EC, and therefore between the doped modulation regions 11. This amounts to crimping the conduction channel of the majority carriers between the doped modulation regions 11, which reduces the modulation current intensity. The power consumption is thus reduced, without affecting the demodulation contrast or the bandwidth insofar as the modulation voltage and the resistivity of the detection material are not modified. This results in improving the performances of the demodulator 1.

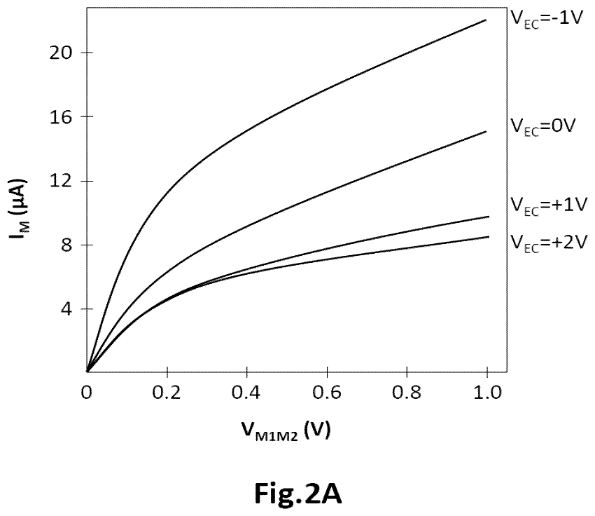

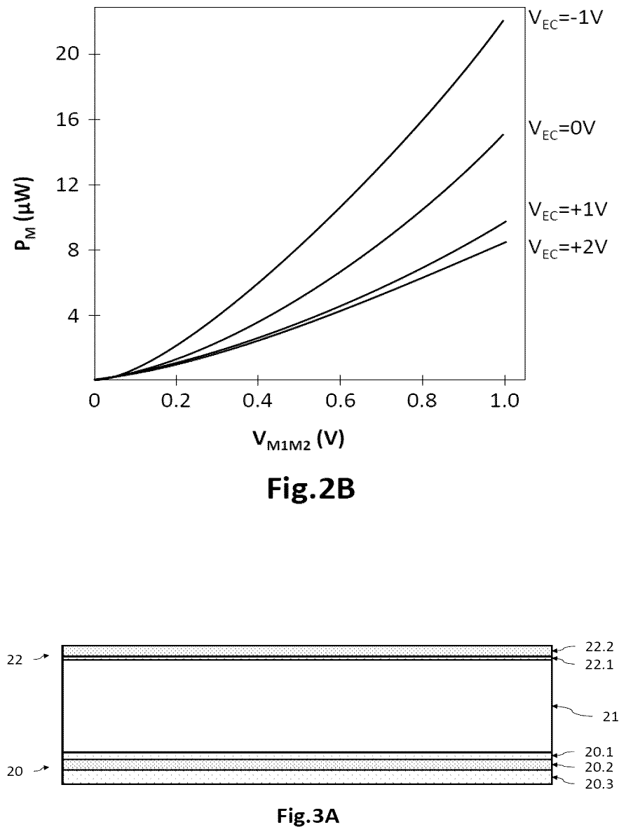

FIGS. 2A and 2B illustrate an evolution, according to the value of the electric potential applied to the central electrode EC, of the intensity I_{M} of the modulation current (FIG. 2A) and the power consumption P_{M} (FIG. 2B). The power consumption corresponds to the electric power P_{M}=ΔV_{M1M2}×I_{M}

In this example, the demodulator 1 includes a detection portion 10 made of germanium having a thickness of 2 μm and unintentionally doped (residual p-doping of the order of 10¹⁶ cm⁻³), wherein doped modulation regions 11 and doped collection regions 12 are located. The central electrode EC is spaced apart from the rear face Far of the detection portion 10 by an interposed portion of the dielectric layer 22 having a thickness of 40 nm of SiO₂. The modulation electrodes M1, M2 and collection electrodes C1, C2, and the central electrode EC, extend into the dielectric layer 22. Moreover, the support layer 20 is a thin layer of monocrystalline silicon, and the peripheral lateral portion 24 is made of polysilicon. Furthermore, a potential difference ΔV_{M1M2} is applied between the modulation electrodes M1, M2, and an electric potential V_{ec} to the central electrode EC.

The potential difference ΔV_{M1M2} is varied between 0 and 1V, for different values of the electric potential V_{ec}: −1V, 0V, +1V and +2V. FIGS. 2A and 2B show a marked reduction in the modulation current intensity I_{M} and the power consumption P_{M} when the central electrode EC is polarized at +1V. This reduction becomes greater if the electrical potential applied to the central electrode EC is increased to +2V. On the other hand, the power consumption P_{M} increases if the central electrode EC is negatively polarized.

It is also possible to simulate (e.g. by means of ATLAS-SILVACO software) the current density of the holes in the detection portion. When the central electrode EC is positively polarized, a reduction in the current of the majority holes between the doped modulation regions 11 is observed due to an accumulation of minority electrons under the interposed part of the dielectric layer 22, under the central electrode EC. The demodulator 1 therefore has a reduced power consumption with a bandwidth and a demodulation contrast which are not impacted by the presence of the positively polarized central electrode EC. In operation, for a majority hole current, the electric potential V_{ec} at the central electrode EC is preferably greater than the potential difference ΔV_{M1M2} between the modulation electrodes M1, M2.

FIGS. 3A to 3H illustrate different steps of a method for manufacturing a demodulator 1 belonging to an array of identical planar demodulators.

With reference to FIG. 3A, a main semiconductor layer 21 is produced by epitaxy from the support layer 20. In this example, the support layer 20 includes a thin layer 20.1 of monocrystalline silicon of a silicon-on-insulator (SOI) substrate. This SOI substrate comprises a thick layer 20.3 of silicon (which will be removed at the end of the method), a layer 20.2 of buried oxide, and the thin layer 20.1 of monocrystalline silicon having a thickness between 10 and 100 nm.

The main semiconductor layer 21 is made of unintentionally doped germanium, and has a thickness between about 700 nm and 3 μm, for example 1.5 μm. It can be carried out as described in particular in the publication by Hartmann & Aubin entitled Assessment of the growth/etch back technique for the production of Ge strain-relaxed buffers on Si, Journal of Crystal Growth, 488 (2018), 43. The main semiconductor layer 21 then has a very low emerging dislocation density (for example in the order of 107 dislocations/cm²), which contributes to reducing the dark current in the detection portion 10 of the demodulator 1.

Alternatively, the main semiconductor layer 21 can be formed from a germanium-on-insulator (GeOI) type substrate. Thus, the support layer 20 can be a germanium nucleation layer of a few tens to a few hundred nanometers resting on a lower layer of about 2 nm of silicon, which rests on an insulating layer of a few tens of nm to a few microns in thickness, then on a silicon substrate. Such a GeOI substrate can be produced by means of the method described in the publication by Reboud et al. entitled Structural and optical properties of 200 mm germanium-on-insulator (GeOI) substrates for silicon photonics applications, Proc. SPIE 9367, Silicon Photonics X, 936714 (Feb. 27, 2015).

Then, a dielectric layer 22 is deposited on the upper face of the main semiconductor layer 21. This dielectric layer 22 can be formed from a first protective sublayer 22.1, deposited by epitaxy on the germanium of the detection portion 10, for example a thin layer of undoped silicon with a thickness ranging from 1 to 4 nm, for example 2 nm, or an aluminum oxide deposited by atomic layer deposition (ALD) having a thickness of the order of 10 to 50 nm. Then, a second sublayer 22.2, made for example of a silicon oxide such as TEOS (tetraethyl orthosilicate) SiO₂ having a thickness in the order of 20 to 500 nm, is deposited on the first sublayer 22.1.

With reference to FIG. 3B, trenches 23, intended to pixelate the demodulators 1 by the peripheral lateral portions 24, are produced, by photolithography and etching. Localized etching of the main semiconductor layer 21 made of germanium is thus carried out to emerge at the support layer 20 made of silicon. Each trench 23 preferably extends continuously in the plane XY around a demodulator 1. Thus, a plurality of detection portions 10 separated from each other by a continuous trench 23 are obtained. They are preferably obtained by an anisotropic etching technique, so as to obtain a substantially vertical lateral edge along the axis Z. The trenches 23 have a transverse dimension (width) in the plane XY which can be between 0.5 μm and 2 μm, for example equal to 1 μm. Thus, the detection portions 10 may have a shape in the plane XY that is, for example, circular, oval, polygonal, for example, square, or any other shape.

With reference to FIG. 3C, the peripheral lateral portion 24 is produced, by epitaxy in the trenches 23 of a crystalline semiconductor material based on silicon. It can particularly consist of silicon or polysilicon. It can be p-doped, for example with boron, with a doping level of the order of 4×10¹⁹ cm⁻³. This material has a thermal expansion coefficient less than that of the germanium-based detection portion 10, such that on returning to ambient temperature (after silicon epitaxy in the trenches), the detection portion 10 exhibits tensile mechanical stress in the plane XY. Thus, an interdiffusion annealing is performed to form the lateral zone 14 based on SiGe. Finally, a chemical-mechanical polishing (CMP) step is then performed, with stoppage on the upper face of the dielectric layer 22, to remove the excess silicon-based material and planarize the upper face of the stack.

With reference to FIG. 3D, the doped modulation regions 11 and the doped collection regions 12 are produced, here by ion implantation. For this, notches 25 are formed in the dielectric layer 22, facing zones of the detection portion 10 intended to form the doped regions 11, 12. In this example, the notches 25 are formed in the oxide sublayer 22.2 to emerge at the silicon sublayer 22.1. Alternatively, they could emerge at the material of the detection portion 10. The width of the notches 25 can be in the order of 0.5 to 1 μm. A thin pre-implantation layer 26, for example an oxide having a thickness of 10 to 30 nm, is then deposited so as to cover the upper face of the sublayer 22.2 and to extend in a conformal manner in the notches 25.

The doped regions 11, 12 are then produced. The doped modulation regions 11 can first be produced, by boron implantation in the detection portion 10 through the designated notches (through an implantation mask, not shown). The p-doping level can be in the order of 10¹⁹ cm⁻³. The doped collection regions 12 are then produced, by phosphorus, or arsenic, implantation in the detection portion 10 through the designated notches. The n-doping level can be in the order of 5×10¹⁸ to 10²⁰ cm⁻³. The implantation mask and the pre-implantation oxide layer 26 are thus removed.

With reference to FIG. 3E, a new dielectric sublayer is deposited on the underlying dielectric layer 22 (the whole being annotated with the same reference 22), so as to cover the doped modulation regions 11, the doped collection regions 12 and the peripheral lateral portion 24. It can be an oxide such as TEOS, having a thickness between 100 and 500 nm, followed by a chemical-mechanical planarization step.

With reference to FIG. 3F, a central notch 27 is produced in the dielectric layer 22 with a view to subsequently forming the central electrode EC. The notch 27 extends facing the central zone Zc, between the doped modulation regions 11. It emerges here at the sublayer 22.1 of the dielectric layer 22. A thin dielectric layer 22.3 made of a material (preferably with a high dielectric constant) selected from SiO2, Al2O3, HfO2, ZrO2, GeO2 among others, with a thickness for example between 20 and 50 nm, is then deposited, in a conformal manner. At least two sublayers, e.g. of SiO2/HfO2 or HfO2/Al2O3 type, etc. can also be used for this layer 22.3. The thickness depends on the dielectric constant of the dielectric material, and can take into account the presence of the sublayer 22.1 (here silicon 2 nm in thickness).

A thin conductive layer EC.1, made of at least one electrically conductive material, is then deposited so as to cover at least the bottom surface of the central notch 27. Here, the thin conductive layer EC.1 also covers the sides of the notch 27 and a part of the upper face of the dielectric layer 22. The thin conductive layer EC.1 can be made of a stack of Ti/TIN (among others), e.g. 10 and 40 nm.

With reference to FIG. 3G, the different electrodes are produced. An additional dielectric layer, here TEOS, is first deposited so as to cover the underlying 22.3 thin dielectric layer 22.3 and fill the central notch 27, followed by a step of chemical-mechanical planarization. The different electrodes are subsequently produced. The central electrode EC comprises a conductive pad EC.2 which extends through a part of the dielectric layer 22 to come into contact with the thin conductive layer EC.1. It is therefore spaced apart from the rear face Far of the detection portion 10 by the sublayer 22.1 and by the thin dielectric layer 22.3. The collection electrodes C1, C2 and the modulation electrodes M1, M2 extend through the dielectric layer 22 to come into electrical contact with the corresponding doped regions 12, 11. They can also comprise a lower part made of Ti/TiN (among others) to optimize the metal/germanium electrical contact, followed by a filling part made of copper. A chemical-mechanical planarization step is then performed.

With reference to FIG. 3H, the demodulator 1 is assembled and connected to a control chip 2. The demodulator is thus turned over to place the face where the electrodes M1, M2, C1, C2, EC emerge in contact with an interconnection face of the control chip 2. The contact pads 3 come into contact with the electrodes and provide hybrid Cu/Cu bonding. Then the thick layer 20.3 of the SOI substrate is removed. Moreover, an optical mask 4 can be disposed facing the front face Fav of the demodulator, allowing light radiation to pass through to the central zone Zc of the detection portion 10. Note that the central electrode EC also acts as a reflector of incident light radiation, thus optimizing the absorption and therefore the performances of the demodulator.

An array of current-assisted photonic demodulators 1 is thus obtained, here in planar configuration, which has enhanced performances, and more specifically a reduced power consumption for a demodulation contrast and a bandwidth which remain optimal.

Specific embodiments have just been described. Different variants and modifications will become apparent to the person skilled in the art.

1. A current-assisted photonic demodulator, configured to detect light radiation, comprising:
a detection portion, made of a material based on germanium, extending vertically between a rear face and a front face parallel with a main plane, the front face being configured to receive light radiation, comprising:
two p-doped modulation regions, configured to generate and modulate a drift current in the detection portion, flush with the rear face and disposed on either side of a central zone of the detection portion;
two n-doped collection regions, configured to collect the photogenerated minority charge carriers during the absorption of light radiation in the detection portion, flush with the rear face and disposed on either side of the central zone and the modulation regions;
a dielectric layer, made of at least one electrically insulating material, and extending on and in contact with the rear face;
and further comprising at least one central electrode, configured to be positively polarized, partially passing through the dielectric layer and spaced apart from the rear face by a non-zero distance, located facing the central zone and disposed, when projected onto the main plane, between the modulation regions.

2. The photonic demodulator according to claim 1, wherein the central electrode is spaced apart from the rear face of the detection portion by a distance between 20 and 50 nm.

3. The photonic demodulator according to claim 1, wherein the dielectric layer, in an interposed part located between the central electrode and the rear face of the detection portion, is made of at least one material selected from a silicon, aluminum, hafnium, zirconium or germanium oxide.

4. The photonic demodulator according to claim 1, wherein the central electrode extends laterally, in projection in the main plane, to the edges of the modulation regions.

5. The photonic demodulator according to claim 1, comprising a peripheral lateral portion surrounding the detection portion in the main plane, made of a silicon-based semiconductor material.

6. The photonic demodulator according to claim 5, wherein the detection portion comprises a lateral zone made of a material based on SiGe, disposed at the interface with the peripheral lateral portion.

7. The photonic demodulator according to claim 1, wherein the central electrode comprises a thin conductive layer which extends into the dielectric layer and a conductive pad coming into contact with the thin conductive layer.

8. The photonic demodulator according to claim 1, comprising collection electrodes, passing through the dielectric layer and coming into electrical contact with the collection regions; and
modulation electrodes, passing through the dielectric layer and coming into electrical contact with the modulation regions.

9. A method for manufacturing a photonic demodulator according to claim 1, comprising the following steps:
producing the detection portion in an unintentionally doped or lightly p-doped germanium-based compound;
producing the p-doped modulation regions and the n-doped collection regions in the detection portion;
depositing a dielectric layer on the rear face of the detection portion;
producing the central electrode through a part of the dielectric layer.
